(19) United States
(12) Patent Application Publication
(10) Pub. No.: US 2005/0187802 A1
(43) Pub. Date: Aug. 25, 2005

(54) Method and system for conducting customer needs, staff development, and persona-based customer routing analysis

(76) Inventor: Harvey Richard Koeppel, New York, NY (US)

Correspondence Address: KILPATRICK STOCKTON LLP, 607 14TH STREET, N.W., WASHINGTON, DC, 20005, US

(21) Appl. No.: 11/057,771

(22) Filed: Feb. 14, 2005

Related U.S. Application Data
(60) Provisional application No. 60/543,930, filed on Feb. 13, 2004.
(60) Provisional application No. 60/613,544, filed on Sep. 27, 2004.

(51) Int. Cl. G06F 17/60

(52) U.S. Cl. 705/4

(57) ABSTRACT

Computer-implemented methods and systems for conducting customer needs, staff development, or persona-based call routing analyses in which a recommendation engine receives baseline information regarding a current status and one or more objectives of a subject and generates assumed information about the subject based on a statistical evaluation of current status and objectives of a plurality of third parties having pre-determined characteristics in common with the subject. The recommendation engine determines a gap between the current status and objectives of the subject and generates and prioritizes a recommendation for one or more proposals for the subject based on the gap. Thereafter, the recommendation engine formulates one or more follow-up questions for the subject.

### PRIORITY APPLICATIONS

This application claims priority to co-pending U.S. Provisional Application No. 60/543,930, filed Feb. 13, 2004, entitled “METHOD AND SYSTEM FOR CONDUCTING CUSTOMER NEEDS ANALYSIS” and co-pending U.S. Provisional Application Ser. No. 60/613,544, filed Sep. 27, 2004, entitled “METHOD AND SYSTEM FOR CONDUCTING CUSTOMER NEEDS, STAFF DEVELOPMENT, AND PERSONA-BASED CUSTOMER ROUTING ANALYSIS”, each of which is incorporated herein by this reference.

### FIELD OF THE INVENTION

The present invention relates generally to a method and system for conducting customer needs, staff development, and persona-based call routing analysis. More particularly, but not by way of limitation, the present invention is a method and system that identifies and prioritizes recommended financial products tailored to individual customers, identifies and prioritizes career goals and objectives for employees, and performs persona-based routing of customers to service agents.

### BACKGROUND OF THE INVENTION

Existing systems that analyze customer needs have various shortcomings. Many of the existing systems focus singularly on the business' point of view. For example, in the context of a bank and its customers, systems exist that analyze bank data to determine which next product or service should be generally offered to the bank's customers. These systems simply take into account bank profitability and overall revenue growth and do not take into account the individual needs of specific clients. For example, certain systems simply assess whether customers already have a particular product or if a particular product has been previously offered to the customers.

More particularly, existing systems do not satisfy the specific financial goals and objectives of customers. For example, in the context of a bank and its customers, the recommendation of particular financial products are driven largely by the bank's goals and objectives as opposed to the personal goals and objectives of an individual client. Accordingly, there is a need for a method and system that identify and prioritize recommended financial products tailored to individual customers.

In addition, there is a need for a staff development analysis system and process that uses the same logic that drives the recommendation engine in the process of identifying and prioritizing recommended financial products and turns that logic inward to look, for example, at identifying and prioritizing recommendations for career goals and objectives for employees.

There is also a need for a persona-based call routing analysis system and process that likewise involves use of the recommendation engine in the routing of work in order to match a customer's needs with an employee's skill and ability, referred to herein as “persona-based” routing, which not only looks, for example, at the specific needs and language of a customer, but also takes into account other customer demographics.

### SUMMARY OF THE INVENTION

It is a feature and advantage of the present invention to provide a method and system for conducting customer needs, staff development, or persona-based call routing analyses, an aspect of which is a financial needs analysis system and process that, through interactive conversations between a customer service agent and a customer, with guidance from novel computer models, enables the customer service agent to help the customer better identify and achieve his/her specific goals and objectives. Although the invention is not limited to banks and banking customers, many of the examples of the novel system and method will be presented in the banking context. Further, the terms customers and client are used interchangeably herein and are meant to have the same meaning.

It is a further feature and advantage of the present invention to provide a financial needs analysis system and process that involves gathering as much information about both the customers' objectives and their current financial situation as is available and utilizing models containing formulas and algorithms to determine the gaps that exist between the customers' goals and objectives and their current positions. Based on these gaps, recommended financial products are prioritized and discussed with the customers in an effort to maximize the probability that the customers will achieve their financial goals in the desired time frame.

It is an additional feature and advantage of the present invention to provide a financial needs analysis system and process which involves, from an information perspective, the inclusion of inputs to the novel recommendation engine of everything that is known about a customer, such as demographic information, meaning his/her name, address, telephone number, and whether he/she rents or owns. Additionally, the inputs include relationship type information, such as whether the customer has a checking account with a particular bank, an investment account with a particular brokerage firm, or an insurance policy with a particular insurance company. The invention also examines transactional information which includes, for example, checking activity, credit card activity, and monthly insurance premiums. In addition, the invention assesses behavioral type information which includes, for example, the customer's propensity to use an ATM or call the 800 service phone number. The invention is focused on understanding the customers and their needs.

It is a still further feature and advantage of the present invention to provide a financial needs analysis system and process which involves, on the output side of an embodiment of the invention, recommendations to the service agent who is dealing with the customer that set forth which products would be the most beneficial to the customer. Further, based on the unique profile of the customer, the products are prioritized. The invention also includes follow-up questions that are specifically formulated such that when answered by the customer and fed into the inventive system, this addition to the database maximizes the effectiveness of the recommendation for the next iteration. The invention, therefore, is self-learning and self-improving. The invention enables a bank to learn more about its customers and offer better recommendations on financial products. The better the recommendations, the more activity there is from the customers which in turn leads to more information about the customers and even better recommendations in the future. Accordingly, the invention helps to build relationships with customers over the long term as opposed to simply executing individual sales of financial products.

It is still another feature and advantage of the present invention to provide a staff development needs analysis system and process that involves use of the same logic that drives the recommendation engine in the process of identifying and prioritizing recommended financial products and turns that logic inward to look, for example, at identifying and prioritizing recommendations for career goals and objectives for employees.

It is a still further feature and advantage of the present invention to provide a persona-based call routing analysis system and process that likewise uses the recommendation engine in the routing of work in order to match a customer's needs with an employee's skill and ability, referred to herein as “persona-based” routing, which not only looks, for example, at the specific needs and language of a customer, but also takes into account other customer demographics, such as age, number of children, marital status, homeownership, and the like.

To achieve the stated and other features, advantages and objects, embodiments of the invention make use, for example, of computer hardware and computer software including, without limitation, machine-readable medium on which is encoded program code for conducting customer needs, staff development, and/or persona-based call routing analyses. Embodiments of the invention provide, for example, computer-implemented methods and systems for conducting customer needs, staff development, or persona-based call routing analyses in which a recommendation engine receives baseline information regarding a current status of a subject and at least one objective of the subject and generates assumed information about the subject based on a statistical evaluation of current status and objectives of a plurality of third parties having pre-determined characteristics in common with the subject.

Based on the baseline information and the assumed information, the recommendation engine for embodiments of the invention determines a gap between the current status of the subject and the one or more objectives of the subject and generates and prioritizes a recommendation for at least one proposal for the subject based on the gap between the current status of the subject and the subject's one or more objectives. Thereafter, the recommendation engine formulates at least one follow-up question for the subject based, for example, on a statistical analysis of the baseline information compared to the assumed information.

In the customer needs analysis aspect for an embodiment of the invention, the baseline information received by the recommendation engine includes, for example, demographic information about a customer, current financial condition information about the customer, and/or information about a relationship between the customer and at least one enterprise. In this aspect, the information that is received can include, for example, information regarding transactions between a customer and at least one enterprise and/or information regarding a propensity of the customer to interact in at least one pre-determined manner with the at least one enterprise. This information is received, for example, by a sales process module having functionality related to customer asset or wealth management, customer liability or debt management, customer cash management, and/or customer insurance or risk management. The information can also include, for example, vital statistics for the customer consisting of actual customer data in connection with a customer account with an enterprise, actual customer data concerning at least one of a credit score, a debt to income ratio, a remaining term of debt, and/or a total liabilities for the customer and can also include known baseline information articulated by the customer.

In the staff development analysis aspect of embodiments of the invention, the baseline information received by the recommendation engine includes, for example, a current career status of an employee of an enterprise, such as evidenced by a current skill level of the employee, information maintained by a human resources department of the enterprise regarding the current skill level of the employee, data from the human resources department of the enterprise regarding an employment level of the employee with which a pre-determined skill set is associated that is pre-defined as demonstrating competency in executing tasks of a pre-determined type, and/or data regarding a licensing level of the employee, in addition to at least one career objective of the employee. In the persona-based call routing aspect of embodiments of the invention, the baseline information received by the recommendation engine includes, for example, data regarding a plurality of pre-determined characteristics of a persona of a customer of an enterprise and at least one objective of the customer in connection with one of an inbound call to and an outbound call from the enterprise.

In the customer needs analysis aspect of embodiments of the invention, generating the assumed information by the recommendation engine involves, for example, generating assumed information regarding the current status of a customer and one or more objectives of the customer, storing the received baseline information and assumed information in a customer information database, receiving additional baseline customer information articulated by the customer in a customer interaction with the enterprise, and supplementing at least part of the assumed information with the additional baseline customer information in the customer information database. In the staff development analysis aspect of embodiments of the invention, generating the assumed information involves, for example, generating assumed information regarding a current career status of an employee and one or more career objectives of the employee. In the persona-based call routing aspect of embodiments of the invention, generating the assumed information involves, for example, generating assumed baseline information regarding a plurality of pre-determined characteristics of a persona of a customer of an enterprise and at least one objective of the customer in connection with one of an inbound call to and an outbound call from an enterprise.

In the customer needs analysis aspect of embodiments of the invention, determining the gap between the current status of the subject and subject's objective by the recommendation engine involves, for example, determining the gap between the current status of a customer and one or more objectives of the customer. In the staff development analysis aspect of embodiments of the invention, determining the gap involves, for example, determining the gap between the current career status of a customer of an enterprise and one or more career objectives of the customer. In the person-based call routing aspect, determining the gap involves, for example, comparing a plurality of pre-determined characteristics of a persona of a customer of an enterprise to a plurality of corresponding pre-determined characteristics of personas of a plurality of service representatives of the enterprise.

In the customer needs analysis aspect of embodiments of the invention, generating and prioritizing the recommendation for one or more one proposals for the subject by the recommendation engine involves, for example, prioritizing a recommendation by a sales process module of the recommendation engine for one or more financial products for a customer based on the gap and prompting a sales representative for a conversation with the customer about the recommended financial product or products. In the staff development analysis aspect of embodiments of the invention, generating and prioritizing the recommendation involves, for example, generating and prioritizing a recommendation for one or more next experiences for an employee based on the gap between a current career status of the employee and one or more career objectives of the employee, such as a recommendation for a next experience for the employee and/or for achieving a skill set necessary for the employee to acquire in order to reach a level of competence corresponding to the employee's career objective. In the persona-based call routing aspect of embodiments of the invention, generating and prioritizing the recommendation involves, for example, generating and prioritizing a referral of a service representative of an enterprise for a customer of the enterprise in connection with one of an inbound call to and an outbound call from an enterprise based at least in part on a comparison of a plurality of pre-determined characteristics of a persona of the customer to a plurality of corresponding pre-determined characteristics or personas of a plurality of service representatives of the enterprise.

In the customer needs analysis aspect of embodiments of the invention, formulating the follow-up question for the subject further involves, for example, receiving additional information from the customer in response to the follow-up question for an iteration by the recommendation engine and generating a recommended solution by the sales process module for a follow-up discussion with the customer based at least in part on additional information received from the customer and the stored baseline and assumed customer information. In the staff development analysis aspect of embodiments of the invention, formulating the follow-up question involves, for example, scheduling training for an employee in an area of demonstrated weakness of the employee. In the persona-based call routing aspect of embodiments of the invention, formulating the follow-up question involves, for example, routing an inbound or outbound call between a customer and a service representative based on a match between a plurality of pre-determined characteristics of a persona of the customer with corresponding pre-determined characteristics of a persona of the service representative.

Additional objects, advantages, and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a diagram illustrating an example of a context of an embodiment of the invention;

FIG. 2 is a diagram that illustrates in greater detail an example of the sales process modules of an embodiment of the invention;

FIG. 3 is flow diagram that illustrates an example of a high level process flow for an example of an embodiment of the invention;

FIG. 4 is a flow diagram that illustrates an example of a client interaction model for an embodiment of the invention;

FIG. 5 is a flow diagram that illustrates an example of information management in accordance with an example of an embodiment of the invention;

FIG. 6 is table that illustrates a summary overview example of an embodiment of the invention;

FIG. 7 is a table that illustrates a summary overview example of another embodiment of the invention;

FIG. 8 is a flow diagram that illustrates an overview example of the analytic process of the recommendation engine for an embodiment of the invention;

FIG. 9 is a flow diagram that illustrates an overview example of the analytic process of the recommendation engine in the customer needs analysis aspect for an embodiment of the invention;

FIG. 10 is a flow diagram that illustrates an overview example of the analytic process of the recommendation engine in the staff development analysis aspect for an embodiment of the invention; and

FIG. 11 is a flow diagram that illustrates an overview example of the analytic process of the recommendation engine in the persona based call routing aspect for an embodiment of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

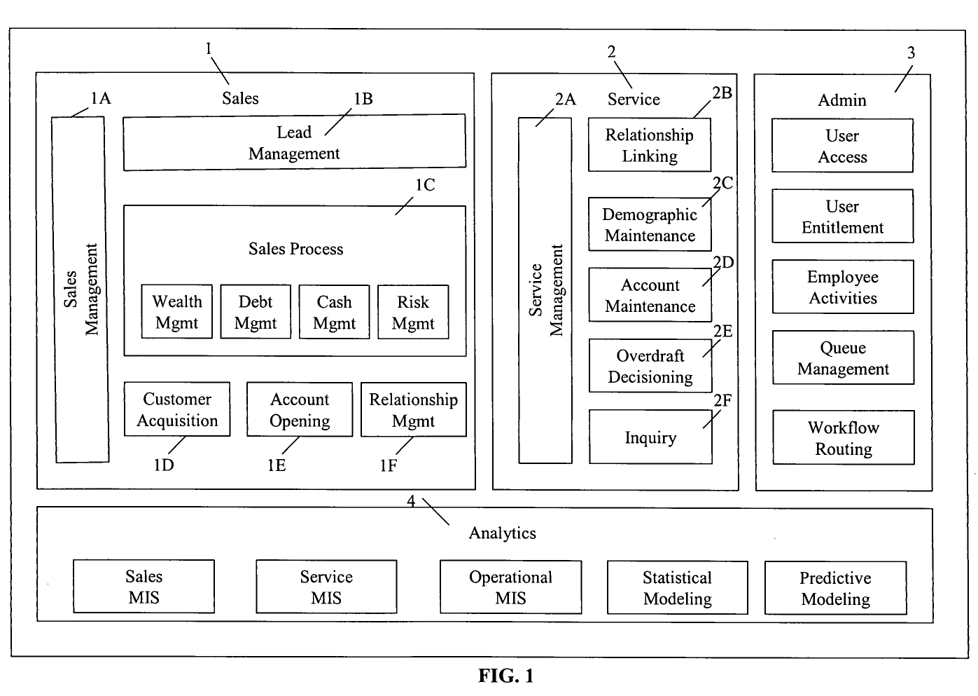

FIG. 1 is a diagram illustrating the context for the various components in an embodiment of the invention including, for example, a Sales component 1, a Service component 2, an Administrative component 3, and an Analytics component 4. The major subcomponents, or modules, of the Sales component 1 in an embodiment of the present invention are identified as 1A-1F. These modules represent specific conversations that a sales agent would have with a customer. The Sales Management module 1A is the discipline that essentially ties together all the aspects of the selling process. The Lead Management module 1B is a function that generates a pipeline of sales prospects into the environment. The Sales Process module 1C involves wealth management, debt management, cash management and risk management. These sub-modules represent different conversations that a sales agent would have with a customer.

Also within the Sales component 1 are modules that represent a life cycle of the relationship with a customer. These modules include Customer Acquisition 1D, Account Opening 1E, and Relationship Management 1F. Customer Acquisition 1D means turning a prospect into a customer. A customer is someone who actually has applied for or has been approved for a specific product or service like a checking account, a CD, a savings account, etc. The Customer Acquisition 1D process involves, for example, identifying the prospect, sharing with him/her possible products and services, and then hopefully moving to the next stage, Account Opening 1E. The Account Opening 1E is where the financial relationship between the prospect and the bank actually occurs. At that point, the relationship needs to be managed. This is identified as the Relationship Management 1F module.

The Service component 2 includes a Service Management module 2A, a Relationship Linking module 2B, a Demographic Maintenance module 2C, an Account Maintenance module 2D, an Overdraft Decisioning module 2E, and an Inquiry module 2F. The Service modules include activities that occur to an account after it is opened, such as changing address information or linking two accounts together for the purpose of getting a better price. For example, if an overdraft occurs and there is a fee to the customer, or if the customer calls concerning a balance inquiry, or had forgotten to write down the amount written, for example, for a check or needs a copy of a check, all of those are the types of activities that occur in the Service modules and serve as inputs to the recommendation engine of the present invention.

Each activity essentially represents a point at which the customer touches the bank and requests a particular service to be performed. This tells the bank more about the customer's specific needs. This activity also provides the bank an opportunity to use the recommendation engine to engage in a sales conversation with the customer based on either specific financial goals or objectives or a specific product.

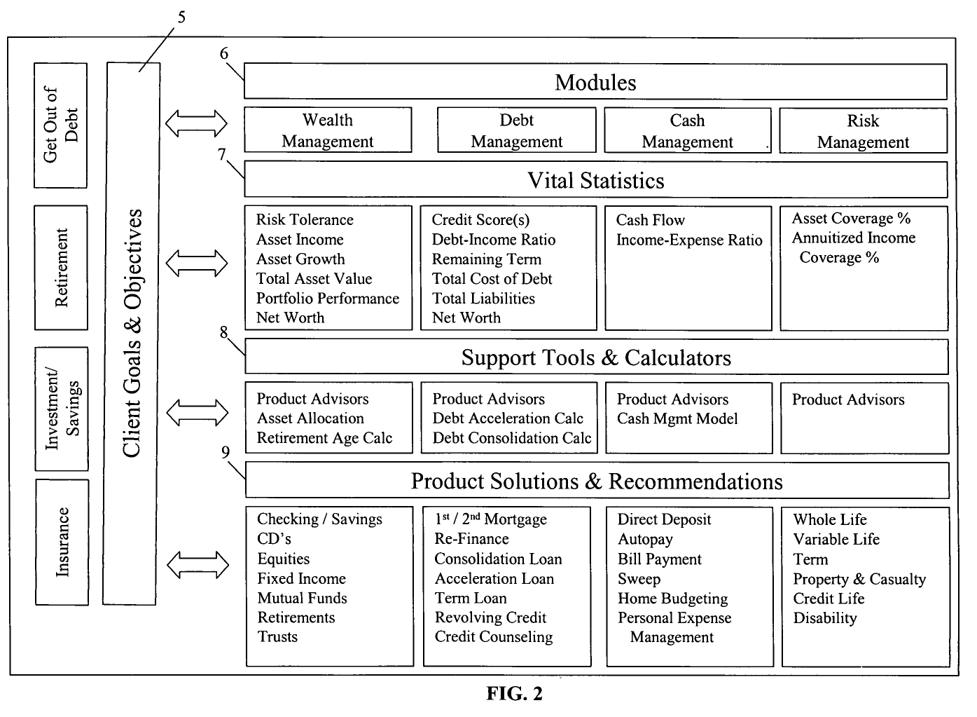

FIG. 2 illustrates in greater detail the Sales Process module referred to in FIG. 1. As part of the technique of managing or helping the client manage his or her financial life, the bank brings to bear disciplines very similar to those used by companies to manage their own financial affairs. For example, wealth management and debt management taken together form a personal balance sheet. Cash management is another way of describing profit and loss, and risk management may be considered a euphemism for insurance.

Embodiments of the invention incorporate financial management models to help manage individual financial success based on the customer's goals and objectives 5. Parallels may be drawn to fourth quarter goals of a business, whether the goals be income, profitability, revenue, number of sales, etc. For example, a customer may have “get out of debt” goals which are typically satisfied by a cash management type of conversation with the sales agent. Retirement goals are mostly associated with asset management or investment-type goals. Investment savings goals can be considered a generic category that would include, for example, saving for college, investing for retirement, or other major financial expenditures that are most often not affordable out of month to month cash flow. Finally, insurance goals are most often a peace-of-mind type of goal where once a customer has done the hard work of building his or her assets and cash flow, the customer naturally wants to protect them.

Any of the goals and objectives 5 can be supported and ultimately satisfied by a mix and match of products. For example, if a customer has a goal to retire, but does not have spare income to invest for retirement, an embodiment of the invention provides for a sales agent to have a conversation with the customer about his or her liability or debt situation and the sales agent can figure out how to do a debt consolidation to free up money on a monthly basis. The money can then be used as an investment on a monthly or periodic basis in order to get closer to the customer's retirement goal. Embodiments of the invention involve substantial interactivity among the goals as well as among the modules.

Referring to FIG. 2, embodiments of the invention include, for example, layers identified as Modules 6, Vital Statistics 7, Support Tools & Calculators 8, and Product Solutions & Recommendations 9. Defined for each of the major disciplines is a set of Vital Statistics 7. The Vital Statistics 7 are presented as examples. Just as a patient visits the doctor to check his or her blood pressure to stay in good health, a bank customer visits a customer service representative to check his or her risk tolerance, asset income, asset growth, etc. to determine the financial health of the asset management portion of the customer's financial life. Similarly, under Debt Management, Vital Statistics 7 are provided and include, for example, the customer's credit score, debt to income ratio, remaining term of debt based on current payment stream, and the total cost of debt which is how much interest is being paid. This translates into less discretionary income available to the customer to invest or save. Similarly, total liabilities and ultimately net worth are Vital Statistics 7. Viewing cash management as a discipline, cash flow and income expense ratio are two examples of Vital Statistics 7. It should be noted that the Vital Statistics 7 presented are merely examples. Not all of the listed Vital Statistics 7 may be used, and others may be added or further defined.

Continuing with a review of Risk Management, the Vital Statistics 7 include, for example, asset coverage percentage. If the customer's house burns down and the house is worth $400,000, the pertinent inquiry is whether there is enough insurance to replace the $400,000 house. Similarly, the annuitized income coverage vital statistic is the equivalent of either unemployment or disability insurance. If the customer is earning $200 a month and is unable to continue that earning stream, the inquiry may be what part of that earning stream is covered through insurance so that the customer knows that he or she can continue to at least support his or her lifestyle and family needs. Accordingly, the Vital Statistics 7 aspect of the present invention is a way to quantify a specific client situation by looking at the difference between the customer's goals, which may be considered long-term objectives, as compared to the customer's vital statistics which are measured at a current point in time. The differences between those two factors are important in terms of prioritizing what products and in what order sales agents should address the issues, which is a novel method and system for recommending courses of action.

Referring further to FIG. 2, in the next level down are the Support Tools and Calculators 8, which become the actual charts and graphs and modeling tools that agents use to actually support their conversation with the customers. For example, Product Advisor is a term that is applied in almost every product situation such as a checking account, an investment account, a savings account, etc., where within the bank or across the banking organization there are multiple variations of a product type. In other words, the bank may offer eight or ten different kinds of checking accounts so it is often very confusing to both the client and the agent as to which is the best checking account for a particular client, given a particular situation. Accordingly, in a sense, the term Product Advisor is a mini-recommendation engine where given a particular set of circumstances on how a client wishes to use the checking account, a checking product advisor is constructed that will help the client and the agent determine, based on the client's scenario, which is the best checking account. Similarly, Asset Allocation helps guide an investment strategy. Retirement Age Calculator is another example of a modeling tool. For example, if the client retires at 65 instead of 63, the Retirement Age Calculator provides a determination as to whether such a change has a meaningful impact on the client.

Referring again to FIG. 2, different types of Support Tools and Calculators are used to support the conversations with clients regarding specific product selections. The final level is Product Solutions & Recommendations 9, which are actual products and services that an agent may be able to offer the client. Accordingly, an embodiment of the present invention as depicted in FIG. 2 illustrates the inventive methodology whereby the steps progress from Client Goals and Objectives 5 to a financial management discipline type conversation using Vital Statistics 7 and Support Tools and Calculators 8 to arrive at specific Product Solutions and Recommendations 9. It should be noted that although FIG. 2 is illustrated by squares within columns, the present invention is not limited as such. The Product Solutions & Recommendations 9 may all be considered as being in a single rectangle across the bottom of the figure. The alignment between certain modules 6 and the products 9 are meant to aid in the understanding of the features of the invention and not to limit its scope.

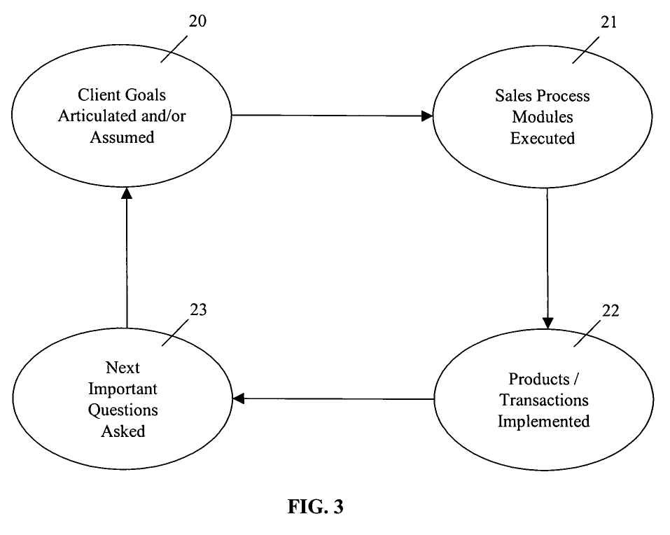

Referring now to FIG. 3, a high level process flow diagram of the invention is presented. A starting point is Client Goals Articulated and/or Assumed 20 which means the client has told a sales agent that he or she is interested, for example, in retiring at 62 or that he or she has a five year old child and a 13-year window to save for college. Articulated means communicated by the client. The recommendation engine of the present invention generally needs more data input than the client has shared in order to provide the most useful result. Not every client or prospect will provide every piece of information that a bank would like to have about the client's financial goals or where else he or she has accounts. In many cases, people bank with multiple institutions specifically for the purpose of not having all of their eggs in one basket or not having their entire relationship with only one financial institution. Often, more sophisticated clients use multiple relationships with multiple financial institutions as a way of negotiating better loan rates, better interest rates on deposits, etc.

Embodiments of the invention recognize that information is incomplete and imperfect. Accordingly, the Assumed information is used to fill the gap caused by the undisclosed information. The combined Client Goals Articulated and/or Assumed 20 stage in the diagram includes that information which has been disclosed by the client and predictive analytics based upon a “people like you” concept. A simple example of the “people like you” concept is provided as follows: A 25 year old single person with no children making $100,000 has not disclosed whether he or she is interested in retirement; however, based on a database of 80 million customers, a bank may be able to determine that under the “people like you” concept, the 25 year old single person is generally not interested in retirement, and therefore, the priority for having the retirement conversation is assumed to be low.

Referring again to FIG. 3, the basic flow starts with the client goals that are a combination of articulated and assumed data 20. The flow then proceeds to the Sales Process modules 21. The output is the recommended product 22, which leads to the “next important question” 23 phase which results in inputs to the model. The subsequent running of the model maximizes the predicted value of the recommendations and continues for the life of the relationship.

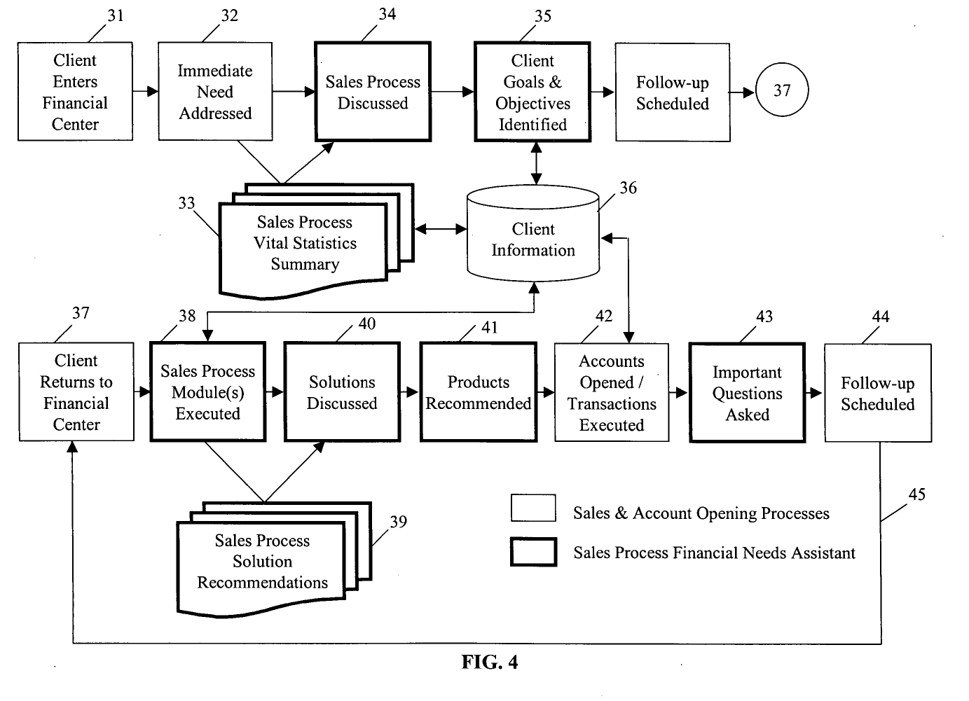

FIG. 4 is a detailed view of an embodiment of the present invention illustrating a client interaction model. FIG. 4 involves a client entering a financial center 31. This first step is not to be limited to a client physically walking into a brick and mortar storefront, but, for example, the client can call a service center or sign on to an online banking portal, etc. Generally, the model requires the client touching the bank through some channel. Before an attempt is made to query or sell a product to a customer, the customer's immediate need is addressed 32. That is, before there is a discussion, for example, regarding retirement planning or saving for college, the immediate need, for example, the customer's desire to report an address change, is addressed. The intent is to ensure that the customer's interactions increases his or her predisposition to want to engage in more conversation. This interaction with the customer provides data for input into a vital statistics summary 33. The vital statistics is recreated by re-running the model which produces recommendations to foster the Sales Process 34 conversation which leads to more information about client goals and objectives 35. This process turns additional assumptions into articulated information. This information is stored in a database 36. In the illustrated embodiment, a follow-up meeting is scheduled; however, a follow-up need not happen because the client may be interested in continuing with an immediate referral to an investment advisor.

If a follow-up is scheduled, the client returns to the bank 37. The Sales Process Modules are executed 38 with solutions recommended 39 and discussed 40, and a product is recommended 41. When the client desires to purchase the product, accounts are opened and transactions are executed 42. The sales agent then asks the next important question 43 in an effort to encourage the client to schedule a follow-up 44 and move through another Sales Process module 45.

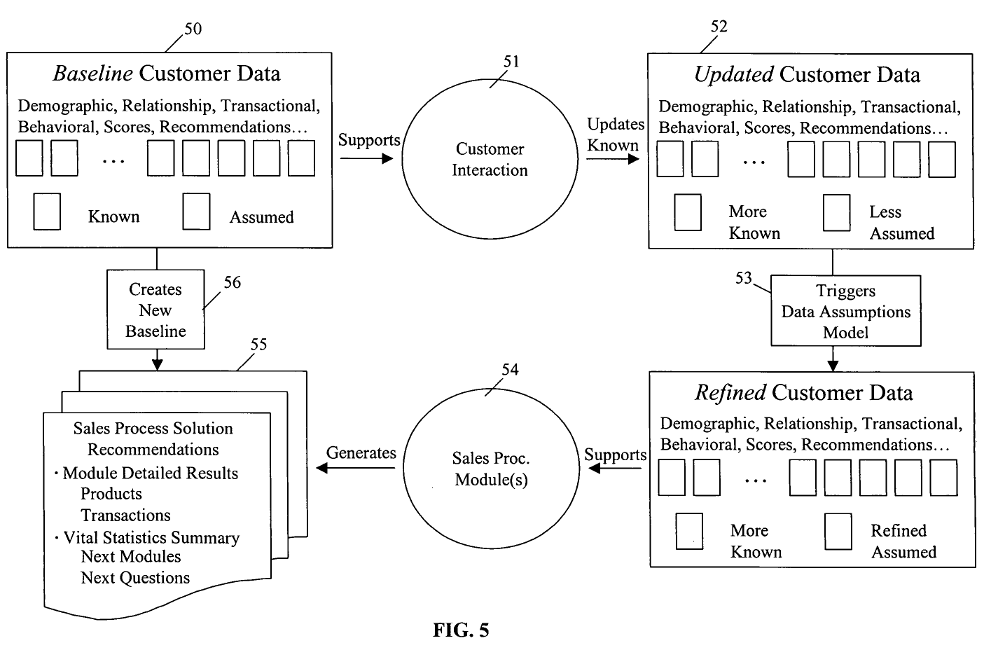

As previously detailed, the customer articulates certain information that is stored in the database. Not all data concerning the customer is known, and therefore, the unknown data is assumed in accordance with an embodiment of the present invention. As illustrated in the embodiment in FIG. 5, both known and assumed baseline customer data 50 needs to be compiled. More specifically, there are, for example, 100 data elements are needed to run the inventive model. At any given point, there are some amounts that are known and some amounts that are unknown. Every time there is an interaction with the customer 51, more information is obtained. The interaction may be, for example, the customer opening a new account, withdrawing money, depositing money, increased his/her balance, etc. These interactions are a way of turning an assumption into known data.

An aspect of the invention is to turn as many assumed data elements as possible into known data elements. The less data elements that are assumed, the better the recommendation. The customer interaction 51 results in more known data and this data is used to update the database 52. The updated customer data 52 triggers the data assumption model to refine the customer data 53, which then prompts the conversations for the Sales Process Module 54. In a case in which the client does not want to have that conversation, there is still a desire to talk to the customer about a product that is specific to his or her needs. The Sales Process Module 54 generates recommendations 55 and creates a new baseline 56. Further, it is desired to ask the customer the next set of questions that, when fed back into the process depicted in FIG. 5, convert further assumed data into known data. An important aspect of an embodiment of the invention is to do a statistical analysis of what is known compared to what is assumed using the appropriate model such that the most important questions are asked in the next sequence so as to maximize the predictive value of the model the next time it is run.

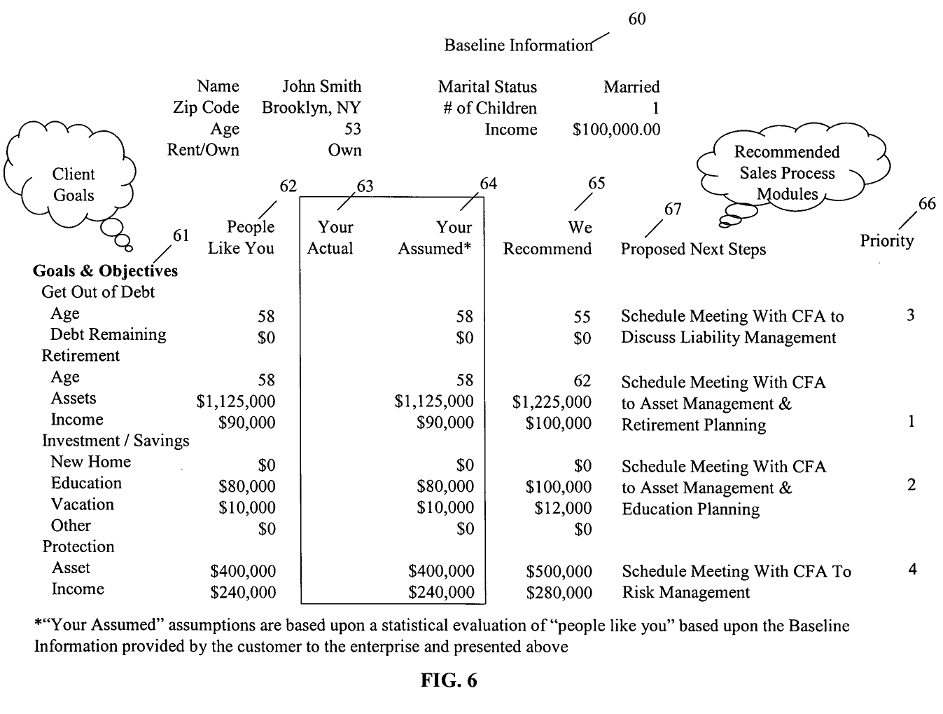

FIG. 6 is a presentation of an embodiment of the inventive system and processes. Referring now to the presentation, there is some minimum basic information, referred to as baseline information 60, from which to start, examples of which are presented in the figure. In this embodiment, the minimal information includes: the customer's name, address, age, whether the customer rents or own, marriage status, number of children, and annual income. Listed also are the goals and objectives 61 of the client. Examples include Get out of Debt, Retirement, Investment/Saving, and Protection. Indented under each goal are the Vital Statistics. The Vital Statistics for the Get out of Debt goal are age and debt remaining. Inserted for these Vital Statistics is data from “People like You” with “You” being defined by the baseline information 60 regarding the customer. As illustrated, John Smith, age 53, lives in Brooklyn, owns his own home, is married with one child and earns $100,000. This represents the baseline 60. The inventive system and methodology generates the “People Like You” data. The “People Like You” 62 data show that at age 58, people like the customer wants to have no debt remaining. When they retire at age 58, they want to have $1,125,000 invested out of which they would typically would want to derive $90,000 a year in income.

In an embodiment of the present invention, the next two columns illustrated in FIG. 6 form the equivalent of the customer's behavior in terms of information actually known about the customer 63 through the customer's own actions or disclosures, and information that is assumed 64 based on the “People Like You” data 62. In the embodiment shown, the actual data column 63 is completely blank because, for example, the customer is new to the bank and the customer has yet expressed his or her views regarding a desired retirement age, the amount of debt the customer is willing to carry into retirement, worth of the customer's home, etc.

In the embodiment illustrated, the inventive system combines the actual data 63 with the assumed data 64 to best understand the customer. In this particular scenario, the understanding is based totally upon assumptions 64 because there is no actual data 63. An embodiment of the present invention takes the aforementioned data and generates a recommendation 65. The inventive system and methodology reviews the difference between the customer's composite, which is again the combination of the actual 63 and assumed 64 data, and the recommendation 65. It is the size of the gap that results in a prioritization 66 and the identification of the type of conversation 67 that the sales agent should have with the customer. The system and methodology identifies the most compelling conversation to have with the customer. In the illustrative embodiment, the most compelling conversation is to have an asset management and retirement planning conversation. A second most important conversation that is suggested to the sales agent is to discuss asset management for education planning. Accordingly, the priority of the conversations is being driven by the gap between what is believed to be a realistic situation for the customer based on his or her vital statistics as compared to a perception of what the customer's vital statistics actually are. The present invention in a very quantitative way assess a client's goals, his or her situation and provides a recommendation in terms of conversations concerning goals and objectives.

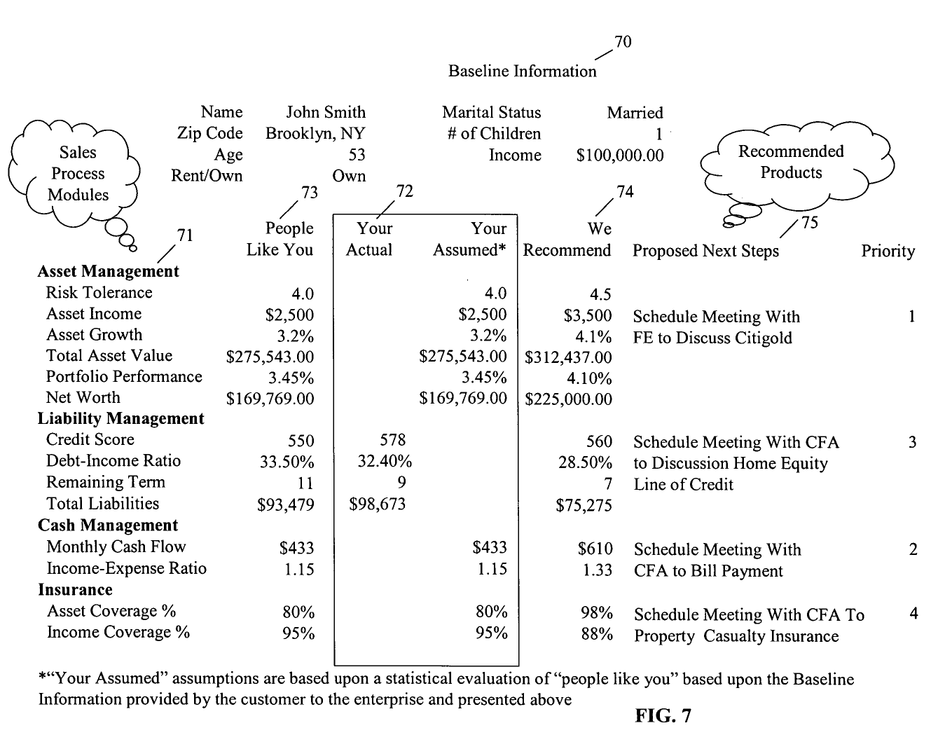

Referring now to FIG. 7, the diagram follows a similar format as illustrated in FIG. 6. The top has the same baseline information 70; however, instead of Goals and Objectives on the left side of the diagram, listed are specific conversations or areas of financial management discipline 71, such as Asset or Wealth Management, Liability or Debt Management, Cash Management and Insurance or Risk Management. In this particular embodiment, the vital statistics include actual data 72, which may have been created because the customer, for example, opened a checking account. Actual information is available concerning the customer's credit score, debt to income ratio, remaining term of debt and total liabilities. Actual information is not available as to the other data so assumptions are made based on the “People Like You” data 73.

The distinctions between FIG. 6 and FIG. 7 should be carefully noted. In FIG. 6, the flow was from goals and objectives 61 to recommended modules 67 identifying a general area of financial health discipline to discuss. FIG. 7 takes those financial management discipline discussions and drills down to specific product priorities 75 for discussion with the client.

As noted, the recommendation engine for embodiments of the invention is used in the process, for example, of defining a client set of goals and objectives (i.e., the client's financial needs), comparing those goals and objectives with the client's current state, and determining the gap that exists between the client's goals and objectives and the client's current state. That gap, in effect, becomes the input to how a sales agent should go about making recommendations for the client in terms of specific financial planning areas, such as retirement planning, getting out of debt, etc., and/or specific products that are relevant to those areas. Thus, in the case of a client's retirement needs, a discussion with the client may include, for example, the difference between an IRA, a Roth IRA, or a 401(k) plan, or in the case of a client's investing for college needs, a discussion with the client may include looking at 529 plans and the like.

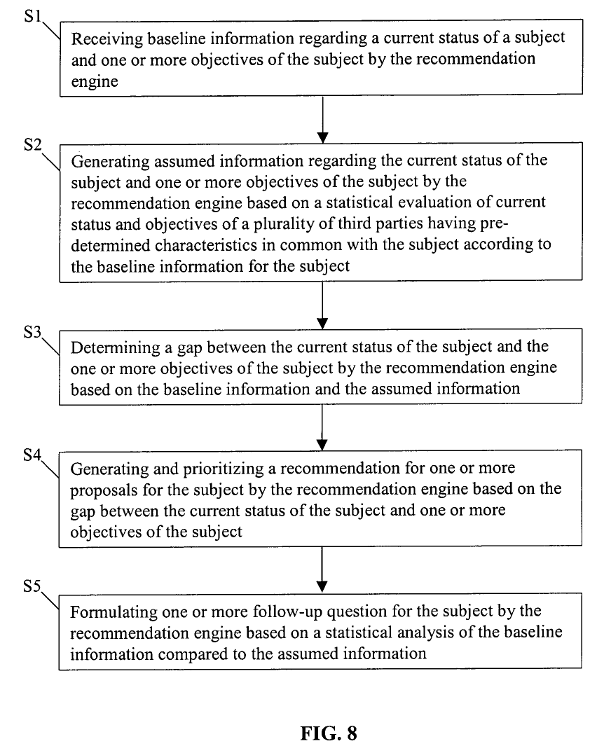

FIG. 8 is a flow diagram that illustrates an overview example of the analytic process of the recommendation engine for an embodiment of the invention. Referring to FIG. 8, at S1, baseline information regarding a current status of a subject and one or more objectives of the subject is received by the recommendation engine. At S2, assumed information regarding the current status of the subject and one or more objectives of the subject are generated by the recommendation engine based on a statistical evaluation of current status and objectives of a plurality of third parties having pre-determined characteristics in common with the subject according to the baseline information for the subject. At S3, the recommendation engine determines a gap between the current status of the subject and the one or more objectives of the subject based on the baseline information and the assumed information, and at S4, the recommendation engine generates and prioritizes a recommendation for one or more proposals for the subject based on the gap between the current status of the subject and one or more objectives of the subject. Thereafter, at S5, the recommendation engine formulates one or more follow-up questions for the subject based on a statistical analysis of the baseline information compared to the assumed information.

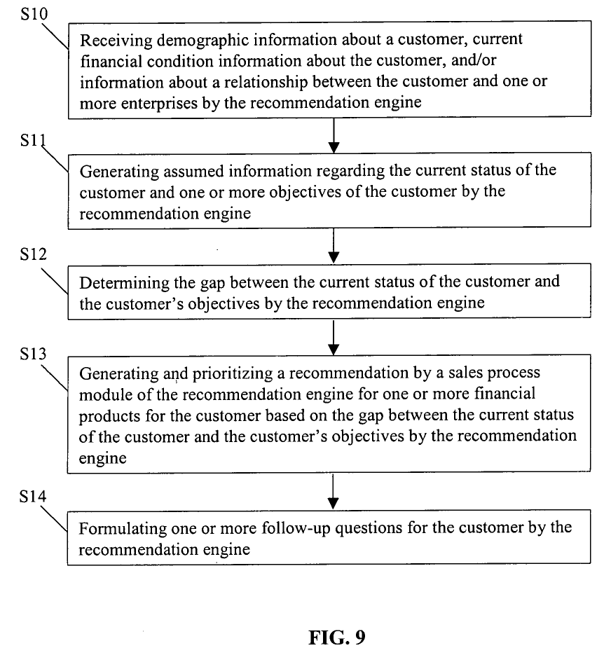

FIG. 9 is a flow diagram that illustrates an overview example of the analytic process of the recommendation engine in the customer needs analysis aspect for an embodiment of the invention. Referring to FIG. 9, at S10, demographic information about a customer, current financial condition information about the customer, and/or information about a relationship between the customer and one or more enterprises is received by the recommendation engine, and at S11, the generation engine generates assumed information regarding the current status of the customer and one or more objectives of the customer. At S12, the recommendation engine determines a gap between the current status of the customer and the customer's objective, and at S13, a sales process module generates and prioritizes a recommendation for one or more financial products for the customer based on the gap between the current status of the customer and the customer's objective. Thereafter, at S14, the recommendation engine formulates one or more follow-up questions for the customer.

An alternative aspect of the invention involves use of the same logic that drives the recommendation engine in the process of identifying and prioritizing recommended financial products and turns that logic inward to look, for example, at identifying and prioritizing recommendations for career goals and objectives for employees. It is to be noted that in this context, the term “employee” is not limited to the employees of any particular type of employer, nor is the term limited to any particular level of employee compensation or responsibility.

In this aspect, the same recommendation engine can also be used, for example, to perform staff development analysis in terms of career planning, performance evaluations, and the like. For example, a typical employee has career goals and objectives, as well as a current state or skill level, depending on how it is measured. In the staff development aspect, the gap can be computed, for example, as to what employees' current skill levels are versus what their next, or future, career goals are or should be. Out of that gap can be garnered, for example, recommended “next experiences” for employees for various purposes, such as managing career paths and/or performance reviews, that are thus factual and quantitative as opposed to subjective and less quantitative.

The information regarding current skill levels or situations and the like, for the staff development aspect includes, for example, the type of information typically maintained by an employer's Human Resources (HR) department, such as an employee's employment level with which a definition of certain skill sets is associated. Thus, in the HR department for a financial institution, a skill set can be defined as competency in executing certain transaction types, such as proficiency at opening checking accounts, answering customer questions regarding statements, generating copies of checks, etc. Such HR job descriptions are typically competently defined with information about specific skills, albeit in perhaps a little less granular detail in some cases.

Another source of information regarding current skill levels in this aspect includes, for example, an employee's licensing level, such as a Series 6 licensing level (entitling a representative to solicit and sell mutual funds, variable annuities and variable life insurance contracts) or a Series 7 licensing level (NASD/NYSE requirement by most broker-dealers for their registered representatives). An employee's licensing level not only represents the employee's entitlement to perform certain transactions, but also evidences the employee's fulfillment of a requirement to demonstrate competency in terms of successful execution of such transactions.

Assume that an employee's current skill level includes opening bank accounts and brokerage accounts that hold mutual funds only and that in order to get to the next skill level, the employee must also be qualified to manage fixed income or equities as part of a balanced portfolio. That is an example of a skill set that would be necessary for the employee to acquire in order to reach an enhanced level of competence, which would therefore be input to an employee performance review and, hopefully, ultimately lead to promotion in the employee's career path.

Information regarding current skill levels of employees, employee job functions, and required job skills in this aspect can likewise be stored on and retrieved from a database by the recommendation engine for embodiments of the invention. In addition, each transaction that includes a customer and an employee not only provides a source of information about the customer, but also provides a potential source of relevant information about the employee. Thus, the staff development aspect for embodiments of the invention involves, for example, building employee profiles in a way that is analogous to building unique customer profiles in the process of identifying and prioritizing recommended financial products for customers. Further, in the staff development aspect, an employer's HR person may act as an employee coach in a role that is likewise analogous, for example, to a financial coach role in the process of identifying and prioritizing recommended financial products for customers.

In the staff development analysis aspect, the employee's career goals and objectives can typically be identified in one or more joint conversations between the employer and the employee. Thereafter, a career plan can be created, and the system for embodiments of the invention effectively monitors performance against that plan, in a way substantially similar to the way a financial plan is created and financial performance monitored against that plan in the financial planning aspect of embodiments of the invention.

In the staff development analysis aspect, the recommendation engine for embodiments of the invention includes functionality, for example, that evaluates employees' performance levels, identifies employees that demonstrate proficiency in certain areas, and automatically assigns such employees more advanced work in the areas of demonstrated proficiency. In addition, the recommendation engine for embodiments of the invention includes functionality, for example, that identifies employees that demonstrate a weakness in certain areas and automatically schedules training for such employees in the areas of demonstrated weakness.

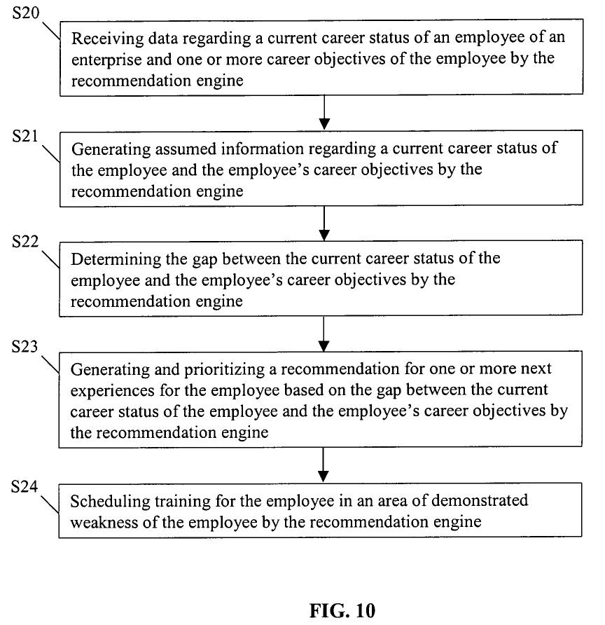

FIG. 10 is a flow diagram that illustrates an overview example of the analytic process of the recommendation engine in the staff development analysis aspect for an embodiment of the invention. Referring to FIG. 10, at S20, data regarding a current career status of an employee of an enterprise and one or more career objectives of the employee is received by the recommendation engine. At S2, the recommendation engine generates assumed information regarding a current career status of the employee and the employee's career objective, and at S22, the recommendation engine determines a gap between the current career status of the employee and the employee's career objective. At S23, the recommendation engine generates and prioritizes a recommendation for one or more next experiences for the employee based on the gap between the current career status of the employee and the employee's career objective, and at S24, the recommendation engine schedules training for the employee in an area of demonstrated weakness of the employee.

A further alternative aspect of the invention involves use of the recommendation engine for embodiments of the invention in the routing of work in order to match a customer's needs with an employee's skill and ability. This aspect, referred to herein as “persona-based” routing, is to be distinguished from currently existing “skills-based” routing, in which the type of transaction which a particular customer seeks to execute, and perhaps the customer's language, are the main drivers of how to determine the best employee in order to satisfy the customer's particular needs at the time.

The persona-based call routing aspect extends the existing skills-based routing concept and proposes persona-based routing, which not only looks, for example, at the specific needs and language of a customer, but also takes into account other customer demographics, such as age, number of children, marital status, homeownership, and the like. For example, if a customer calls about a retirement planning question or problem, such as why an expected deposit was not automatically made into the customer's 401(k) plan, the recommendation engine for embodiments of the invention can route the customer's call to an employee who has had the same or similar experiences with which the customer is attempting to deal, so there is a much more direct interpersonal bond between the customer and the employee on the phone. In other words, persona-based routing for embodiments of the invention is driven by common experience and background shared by the customer and the employee, in addition to identification of a specific product and language.

A key feature of the persona-based routing aspect for an embodiment of the invention is matching an appropriate employee (agent) profile with a customer profile. In this aspect, it is assumed that the skill level of staff is constant and the same across all staff personas. For example, a fifty-something year old customer would not be paired with a twenty-something employee (agent). For purposes of credibility and affinity with the customer, such a pairing would not be appropriate. A unique and key feature and unique differentiator of the persona-based routing aspect of the invention is a recognition that the “people like you” concept extends to the employee (agent) as well. Again, the assumption in this aspect is that the skill level, licensing level, entitlement level, and the like, is the same across all staff personas.

The persona-based routing aspect for embodiments of the invention can be used in connection with either inbound or outbound calling. The persona-based routing concept involves matching the persona of an employee/agent of an entity with the persona of a customer far more precisely, based on the premise that like-minded or like-experienced people are likely to be more like-minded with one another and thus are more likely to have a positive experience with each other.

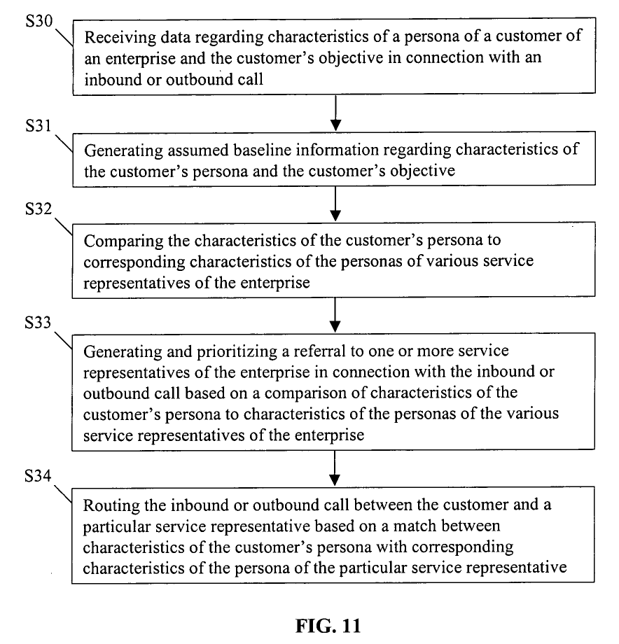

FIG. 11 is a flow diagram that illustrates an overview example of the analytic process of the recommendation engine in the persona-based call routing analysis aspect of an embodiment of the invention. Referring to FIG. 11, at S30, data regarding, for example, characteristics of a persona of a customer of an enterprise and the customer's objective in connection with an inbound or outbound call is received by the recommendation engine, and at S31, the recommendation engine generates assumed information regarding characteristics of the customer's persona and the customer's objective. At S32, the recommendation engine compares the characteristics of the customer's persona to corresponding characteristics of the personas of various service representatives of the enterprise, and at S33, the recommendation engine generates and prioritizes a referral to one or more service representatives of the enterprise for the customer in connection with the inbound or outbound call based at least in part on a comparison of characteristics of the customer's persona to the characteristics of the personas of the various service representatives of the enterprise. Thereafter, at S34, the recommendation engine routes an inbound or outbound call between the customer and a particular service representative based on a match between the characteristics of the customer's persona with corresponding characteristics of the persona of the particular service representative.

Embodiments of the present invention have now been described in fulfillment of the above objects. It will be appreciated that these examples are merely illustrative of the invention. Many variations and modifications will be apparent to those skilled in the art.

1. A method for conducting customer needs, staff development, or persona-based call routing analyses, comprising:
receiving baseline information regarding a current status of a subject and at least one objective of the subject by a recommendation engine;
generating assumed information regarding the current status of the subject and the at least one objective of the subject by the recommendation engine based on a statistical evaluation of current status and objectives of a plurality of third parties having pre-determined characteristics in common with the subject according to the baseline information for the subject;
determining a gap between the current status of the subject and the at least one objective of the subject by the recommendation engine based on the baseline information and the assumed information;
generating and prioritizing a recommendation for at least one proposal for the subject by the recommendation engine based on the gap between the current status of the subject and the at least one objective of the subject; and
formulating at least one follow-up question for the subject by the recommendation engine based on a statistical analysis of the baseline information compared to the assumed information.

2. The method of claim 1, wherein receiving the baseline information further comprises receiving at least one of demographic information about a customer, current financial condition information about the customer, and information about a relationship between the customer and at least one enterprise.

3. The method of claim 1, wherein receiving the baseline information further comprises receiving at least one of information regarding transactions between a customer and at least one enterprise and information regarding a propensity of the customer to interact in at least one pre-determined manner with the at least one enterprise.

4. The method of claim 1, wherein receiving the baseline information further comprises receiving the baseline information by a recommendation engine sales process module having functionality related to customer asset or wealth management, customer liability or debt management, customer cash management, and customer insurance or risk management.

5. The method of claim 1, wherein receiving the baseline information further comprises receiving vital statistics for the customer consisting at least in part of one of actual customer data in connection with a customer account with an enterprise, actual customer data concerning at least one of a credit score, a debt to income ratio, a remaining term of debt, and a total liabilities for the customer.

6. The method of claim 1, wherein receiving the baseline information further comprises receiving known baseline information articulated by a customer.

7. The method of claim 1, wherein receiving the baseline information further comprises receiving data regarding a current career status of an employee of an enterprise and at least one career objective of the employee.

8. The method of claim 7, wherein receiving data regarding the current career status of the employee further comprises receiving data regarding a current skill level of the employee.

9. The method of claim 8, wherein receiving the data regarding the current skill level of the employee further comprises receiving information maintained by a human resources department of the enterprise regarding the current skill level of the employee.

10. The method of claim 9, wherein receiving the information maintained by the human resources department further comprises receiving data from the human resources department of the enterprise regarding an employment level of the employee with which a pre-determined skill set is associated that is pre-defined as demonstrating competency in executing tasks of a pre-determined type.

11. The method of claim 10, wherein receiving the data regarding the employment level of the employee further comprises receiving data regarding a licensing level of the employee.

12. The method of claim 1, wherein receiving the baseline information further comprises receiving data regarding a plurality of pre-determined characteristics of a persona of a customer of an enterprise and at least one objective of the customer in connection with one of an inbound call to and an outbound call from the enterprise.

13. The method of claim 1, wherein generating the assumed information further comprises generating assumed information regarding the current status of a customer of an enterprise and the at least one objective of the customer.

14. The method of claim 13, wherein generating the assumed information further comprises storing the received baseline information and the assumed information regarding the current status of the customer and the at least one objective of the customer in a customer information database by the recommendation engine.

15. The method of claim 14, wherein generating the assumed information further comprises receiving additional baseline customer information articulated by the customer in a customer interaction with the enterprise.

16. The method of claim 15, wherein receiving the additional baseline customer information further comprises supplementing at least part of the assumed information with the additional baseline customer information in the customer information database.

17. The method of claim 1, wherein generating the assumed information further comprises generating assumed baseline information regarding a current career status of an employee of an enterprise and at least one career objective of the employee.

18. The method of claim 1, wherein generating the assumed information further comprises generating assumed baseline information regarding a plurality of pre-determined characteristics of a persona of a customer of an enterprise and at least one objective of the customer in connection with one of an inbound call to and an outbound call from the enterprise.

19. The method of claim 1, wherein determining the gap between the current status of the subject and the at least one objective of the subject further comprises determining the gap between the current status of a customer of an enterprise and at least one objective of the customer.

20. The method of claim 1, wherein determining the gap between the current status of the subject and the at least one objective of the subject further comprises determining a gap between a current career status of an employee of an enterprise and at least one career objective of the employee.

21. The method of claim 1, wherein determining the gap between the current status of the subject and the at least one objective of the subject further comprises comparing a plurality of predetermined characteristics of a persona of a customer of an enterprise to a plurality of corresponding pre-determined characteristics of personas of a plurality of service representatives of the enterprise.

22. The method of claim 1, wherein generating and prioritizing a recommendation for the at least one proposal for the subject further comprises generating and prioritizing a recommendation by a sales process module of the recommendation engine for at least one financial product for a customer of an enterprise based on the gap between a current status of the customer and at least one objective of the customer.

23. The method of claim 22, wherein generating and prioritizing the recommendation by the sales process module further comprises prompting a sales representative of the enterprise for a conversation with the customer about the recommended financial product.

24. The method of claim 1, wherein generating and prioritizing the recommendation for at least one proposal for the subject further comprises generating and prioritizing a recommendation for at least one next experience for an employee of the enterprise based on the gap between a current career status of the employee and at least one career objective of the employee.

25. The method of claim 24, wherein generating and prioritizing the recommendation for the at least one next experience for the employee further comprises generating a recommendation for achieving a skill set necessary for the employee to acquire in order to reach a level of competence corresponding to the at least one career objective of the employee.

26. The method of claim 1, wherein generating and prioritizing the recommendation for the at least one proposal for the subject further comprises generating and prioritizing a referral of a service representative of an enterprise for a customer of the enterprise in connection with one of an inbound call to and an outbound call from the enterprise based at least in part on a comparison of a plurality of pre-determined characteristics of a persona of the customer to a plurality of corresponding pre-determined characteristics of personas of a plurality of service representatives of the enterprise.

27. The method of claim 26, wherein generating and prioritizing the referral to the service representative for the customer further comprises identifying and matching characteristics of a persona of the customer with a persona of the customer service representative.

28. The method of claim 1, wherein formulating the follow-up question for the subject further comprises formulating the at least one follow-up question for a customer of an enterprise by the recommendation engine.

29. The method of claim 28, wherein formulating the at least one follow-up question for the customer further comprises receiving additional information from the customer in response to the follow-up question for an iteration by the recommendation engine.

30. The method of claim 29, wherein formulating the at least one follow-up question for the customer further comprises generating a recommended solution by the sales process module for a follow-up discussion with the customer based at least in part on additional information received from the customer and stored baseline and assumed customer information from a client information database.

31. The method of claim 1, wherein formulating the follow-up question for the subject further comprises scheduling training for an employee of an enterprise in an area of demonstrated weakness of the employee by the recommendation engine

32. The method of claim 1, wherein formulating the follow-up question for the subject further comprises routing one of an inbound and outbound call between a customer of an enterprise and a service representative of the enterprise based on a match between a plurality of pre-determined characteristics of a persona of the customer with corresponding pre-determined characteristics of a persona of the service representative.

33. A computer-implemented system for conducting customer needs, staff development, or persona-based call routing analyses, comprising:
means for receiving baseline information regarding a current status of a subject and at least one objective of the subject by a recommendation engine;
means for generating assumed information regarding the current status of the subject and the at least one objective of the subject by the recommendation engine based on a statistical evaluation of current status and objectives of a plurality of third parties having pre-determined characteristics in common with the subject according to the baseline information for the subject;
means for determining a gap between the current status of the subject and the at least one objective of the subject by the recommendation engine based on the baseline information and the assumed information;
means for generating and prioritizing a recommendation for at least one proposal for the subject by the recommendation engine based on the gap between the current status of the subject and the at least one objective of the subject; and
means for formulating at least one follow-up question for the subject by the recommendation engine based on a statistical analysis of the baseline information compared to the assumed information.

34. A machine-readable medium on which is encoded program code for conducting customer needs, staff development, or persona-based call routing analyses, the program code comprising instructions for:
receiving baseline information regarding a current status of a subject and at least one objective of the subject by a recommendation engine;
generating assumed information regarding the current status of the subject and the at least one objective of the subject by the recommendation engine based on a statistical evaluation of current status and objectives of a plurality of third parties having pre-determined characteristics in common with the subject according to the baseline information for the subject;
determining a gap between the current status of the subject and the at least one objective of the subject by the recommendation engine based on the baseline information and the assumed information;
generating and prioritizing a recommendation for at least one proposal for the subject by the recommendation engine based on the gap between the current status of the subject and the at least one objective of the subject; and
formulating at least one follow-up question for the subject by the recommendation engine based on a statistical analysis of the baseline information compared to the assumed information.
